(19) United States
(12) Patent Application Publication
(10) Pub. No.: US 2014/0034027 A1
(43) Pub. Date: Feb. 6, 2014

(54) EXHAUST GAS RE-CIRCULATION SYSTEM

(71) Applicants: Anthony L. De Luca, Metamora, IL (US); Scott R. Schuricht, Edwards, IL (US)

(72) Inventors: Anthony L. De Luca, Metamora, IL (US); Scott R. Schuricht, Edwards, IL (US)

(73) Assignee: Caterpillar Inc., Peoria, IL (US)

(21) Appl. No.: 13/562,648

(22) Filed: Jul. 31, 2012

(51) Int. Cl. F02B 47/08; B21K 3/00; F02M 25/07

(52) U.S. Cl. 123/568.12; 29/888.01

(57) ABSTRACT

A system is provided. The system includes a coolant loop, a pump, and an exhaust gas re-circulation (EGR) cooler. The pump is disposed in the coolant loop. The EGR cooler is fluidly connected to the pump. Further, the system includes at least one flow control device to selectively isolate the EGR cooler from the coolant loop based on an operation mode of the pump.

### TECHNICAL FIELD

The present disclosure relates to engine systems and more particularly to an exhaust gas re-circulation system of the engine system.

### BACKGROUND

An exhaust gas re-circulation (EGR) cooler may be provided in an engine system to cool heated exhaust gases being re-circulated into an intake manifold. Occasionally, the EGR cooler may experience failure. In certain circumstances EGR failure may cause a coolant flowing through the EGR cooler to leak into an EGR exhaust loop. During engine shutdown, this leaked coolant may collect in the intake manifold and/or cylinders of the engine. The collected coolant may then cause hydro-lock when the engine is restarted.

For example, U.S. Pat. No. 7,845,339 ('339 patent) relates to a cooling system for an engine. In one embodiment, the cooling system may include a heat exchanger, a pump coupled to the heat exchanger, an EGR cooler coupled to the pump, and a first valve coupled to the EGR cooler and the heat exchanger. When the first valve is in a first position, the first valve directs a coolant to the heat exchanger and when the first valve is in a second position, the heat exchanger is bypassed and coolant flows directly to the pump.

The configuration described in the '339 patent maximizes coolant flow when the first valve is in an open position and allows the engine to warm up when the first valve is in the closed position. However, the '339 patent does not prevent the coolant in the EGR cooler from draining into the intake manifold or cylinders of the engine. Thus, the '339 patent does not prevent hydro-lock of the engine.

### SUMMARY OF THE DISCLOSURE

In one aspect of the present disclosure, a system is provided. The system includes a coolant loop, a pump, and an exhaust gas re-circulation (EGR) cooler. The pump is disposed in the coolant loop. The EGR cooler is fluidly connected to the pump. Further, the system includes at least one flow control device to selectively isolate the EGR cooler from the coolant loop based on an operation mode of the pump.

In another aspect, a method for controlling coolant flow into an exhaust gas re-circulation (EGR) cooler is provided. The method provides a coolant loop. The method provides a pump in the coolant loop. Further, the method provides the (EGR) cooler fluidly connected to the pump. Also, the method provides at least one flow control device to selectively isolate the EGR cooler from the coolant loop based on an operation mode of the pump.

Other features and aspects of this disclosure will be apparent from the following description and the accompanying drawings.

### BRIEF DESCRIPTION OF THE DRAWINGS

FIG. 1 is a flow diagram of an exhaust gas re-circulation (EGR) system, according to one embodiment of the present disclosure;

FIG. 2 is a block diagram of an exemplary EGR cooler disposed in a coolant loop; and

FIG. 3 is a flowchart of a method for controlling coolant flow into an EGR cooler.

### DETAILED DESCRIPTION

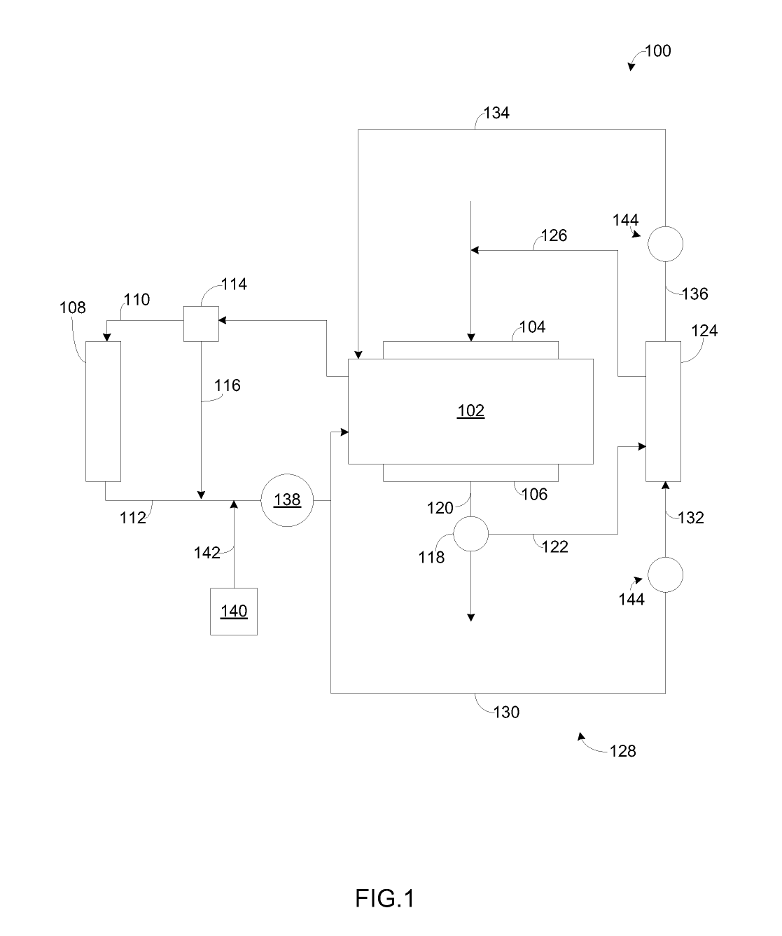

FIG. 1 illustrates an exemplary exhaust gas re-circulation (EGR) system 100 according to one embodiment of the present disclosure. The EGR system 100 may include a power source 102. In one embodiment, the power source 102 may include for example, a diesel engine, a gasoline engine, a gaseous fuel powered engine such as a natural gas engine, a combination of known sources of power or any other type of power source apparent to one of skill in the art. As shown, the power source 102 may include an intake manifold 104 and an exhaust manifold 106. The intake manifold 104 is configured to receive intake air, which may or may not be mixed with fuel. Products of combustion may be exhausted from the power source 102 via the exhaust manifold 106.

The power source 102 may be coupled a cooling system including passages within the power source 102 through which a coolant may flow. A heat exchanger or a radiator 108 may be fluidly connected to the power source 102, in order to dissipate heat from the coolant leaving the power source 102. A person of ordinary skill in the art will appreciate that any suitable coolant known in the art may be used, for example the coolant may include distilled water or a mixture of water, antifreeze and other additives. The antifreeze may be added for freeze protection, while the other additives may be added for corrosion protection. A first passageway 110 may supply a coolant flow from the power source 102 to an inlet of the radiator 108. Further, a second passageway 112 may be connected to an outlet of the radiator 108 to permit flow of the coolant away from the radiator 108.

In one embodiment, a thermostat controlled valve 114 may be disposed in the first passageway 110. The thermostat controlled valve 114 may divert at least a portion of the coolant flow into a bypass branch 116 if the temperature of the coolant is below a pre-determined threshold level. For example, when the temperature of the coolant flow from the power source 102 may be below the pre-determined threshold level, then the coolant flow may be routed through the bypass branch 116, away from the radiator 108. In another embodiment, the coolant flow may be routed towards the radiator 108 when the temperature of the coolant flow from the power source 102 may be above the pre-determined threshold level. A person of ordinary skill in the art will appreciate that the placement of the thermostat controlled valve 114 depicted in the accompanied figures illustrates an outlet controlled cooling system. An inlet controlled cooling system, wherein the thermostat controlled valve 114 may be placed within the second passageway 112 also lies within the scope of this disclosure.

In one embodiment, a portion of the exhaust gas may be recirculated to the intake manifold 104 of the power source 102. One of ordinary skill in the art will appreciate that when combustion temperatures exceed about 1372° C., atmospheric nitrogen may react with oxygen, forming various nitrogen oxides (NOx). In order to reduce the formation of NOx, the exhaust gas recirculation process may be used to keep the combustion temperature below a NOx threshold. As shown in FIG. 1, a valve 118 in an exhaust conduit 120 may be used to control an exhaust gas recirculation flow rate. Alternatively, the valve 118 may also be placed in the second EGR exhaust line 126. In one embodiment, the exhaust gas may flow along a first EGR exhaust line 122 to an EGR cooler 124 for cooling. Thereafter, the cooled exhaust gas may be introduced into the intake manifold 104 via a second EGR exhaust line 126.

The EGR cooler 124 may be configured to cool the exhaust gas by heat exchange with the coolant. A person of ordinary skill in the art will appreciate that the EGR cooler 124 may include any air/coolant heat exchanger known in the art. In the present disclosure, a coolant loop 128 may be associated with the EGR cooler 124. It should be noted that the coolant loop 128 may be interconnected with a circuit that supplies the coolant flow to the power source 102. In one embodiment, the coolant loop 128 may include a first fluid communication line 130 connected to the second passageway 112 of the cooling system of the power source 102. The first fluid communication line 130 may allow the coolant flow into the EGR cooler 124 at an inlet 132. Further, in one embodiment, a second fluid communication line 134 may connect an outlet 136 of the EGR cooler 124 to the power source 102. Alternative embodiments include configurations wherein the outlet 136 of the EGR cooler 124 may be directly connected to the first passageway 110 by a fluid communication line (not shown).

The second fluid communication line 134 may be configured to carry the coolant away from the EGR cooler 124. A person of ordinary skill in the art will appreciate that when the power source 102 is running, or for a time after power source 102 shutdown, the coolant entering the EGR cooler 124 may be relatively cooler than the coolant leaving the EGR cooler 124 due to the heat exchanging effect of the EGR cooler 124. For example, in some machines, a temperature rise of about between 5 to 10° C. may be observed across the coolant entering and leaving the EGR cooler 124.

In another embodiment, the second fluid communication line 134 may be fluidly connected to other coolers in the system, for example, an oil cooler. The coolant flow from these coolers may combine and collectively drain into the power source 102. A person of ordinary skill in the art will appreciate that the connections and components shown in the accompanied figures are merely on an exemplary basis and do not limit the scope of this disclosure. It should be understood that the connections between the components in the system may be provided by tubes, hoses, or other devices known in the art. Parameters like positioning and dimensions may vary. Other similar arrangements of the coolant loop 128 lie within the scope of this disclosure.

Referring to FIG. 1, a pump 138 may be disposed in the coolant loop 128 to circulate the coolant through the EGR cooler 124. In one embodiment, the pump 138 may either be in an active state or an inactive state. Further, the pump 138 may have a variable displacement based on operating parameters of the power source 102, such as, but not limiting to, speed of the power source 102. Alternatively, the pump 138 may include a fixed displacement pump. It should be noted that a flow rate of the pump 138 may be controlled based on a temperature sensed in the cooled exhaust gas or a temperature differential between coolant entering and leaving the EGR cooler 124, and the like. Further, a shunt tank 140 may be fluidly connected to the EGR system 100 via a shunt line 142. A person of ordinary skill in the art will appreciate that the shunt tank 140 may provide a positive pressure to the pump 138 to improve cavitation performance. Also, the shunt tank 140 may provide volume for the thermal expansion of the coolant. It should be noted that the shunt tank 140 may facilitate de-aeration of the coolant flow in the system. The shunt tank 140 may also serve as a coolant reservoir to ensure the presence of coolant despite evaporative losses over time. Typically, the shunt tank 140 is located such that the shunt tank 140 may supply coolant to the coolant loop 128 via a gravity feed, e.g., the coolant in the shunt tank 140 is at a higher gravitational potential energy than other coolant in the coolant loop 128; such a configuration may ensure supply of coolant to the pump 138, even when the pump 138 is in an off state.

In the present disclosure, as shown in FIG. 1, at least one flow control device 144 may be provided in the coolant loop 128. The flow control device 144 may be configured to selectively isolate the EGR cooler 124 from the coolant loop 128. In one embodiment, the flow control device 144 may be provided in the first fluid communication line 130. In another embodiment, the flow control device 144 may be provided immediately adjacent to the inlet 132 of the EGR cooler 124. In yet another embodiment, the flow control device 144 may also be provided in the second fluid communication line 134, and more specifically immediately adjacent to the outlet 136 of the EGR cooler 124.

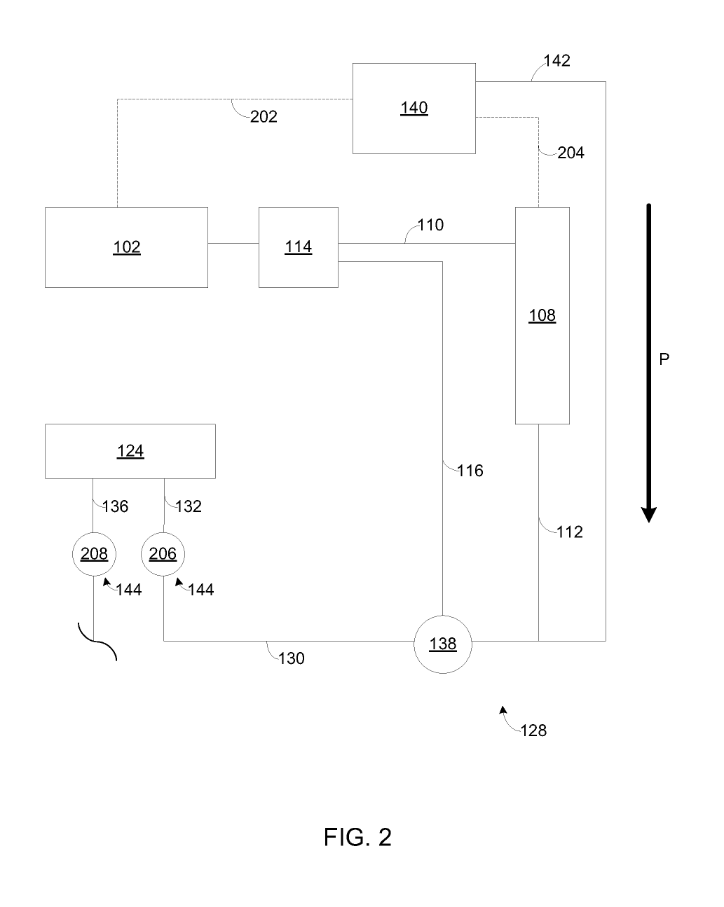

FIG. 2 depicts an exemplary arrangement of the EGR cooler 124 and the coolant loop 128, showing the positioning of the different components in the system. It should be noted that the other components in the system are omitted merely for the purpose of clarity. In one embodiment, as shown in FIG. 2, the shunt tank 140 may be located at a relatively high point in the system as compared to the other components of the EGR system 100. Arrowhead P shown in FIG. 2 is indicative of the direction that gravity may act on the components in the system. It should be noted that based on the position of the component in the system, components located higher up have a higher potential energy than the components located at a relatively lower position. In one embodiment, vent lines 202, 204 may fluidly connect the power source 102 and the radiator 108 to the shunt tank 140 respectively. A person of ordinary skill in that art will appreciate that the coolant flowing through the vent lines 202, 204 may contain air bubbles. In one embodiment, the shunt tank 140 may be configured to de-aerate the coolant received via the vent lines 202, 204.

As shown, in another embodiment, the shunt line 142 may fluidly connect the shunt tank 140 to the pump 138. It should be understood that the de-aerated coolant may be returned for circulation in the system via the shunt line 142. In another embodiment, the pump 138 may receive the coolant flow from the thermostat controlled valve 114 via the bypass line 116. Further, the opening or closing of the thermostat controlled valve 114 may be based on the temperature of the coolant. For example, when the thermostat controlled valve 114 is either closed or partially open, then a portion of the coolant flow may pass through the bypass line 116. In yet another embodiment, the pump 138 may receive the coolant flow from the radiator 108 via the second passageway 112. The pump 138 may provide the coolant flow to the EGR cooler 124 via the first fluid communication line 130.

In one embodiment, the flow control device 144 may include a mechanically controlled first and second check valve 206, 208 such as, for example, a ball check valve or a spring loaded check valve having a spring force. As shown in FIG. 2, the first check valve 206 may be provided in the coolant loop 128 between the EGR cooler 124 and the pump 138. Additionally, in one embodiment, the second check valve 208 may be provided at the outlet 136 of the EGR cooler 124. A person of ordinary skill in the art will appreciate that the positioning of the flow control device 144 shown in the accompanied drawings is merely on an exemplary basis and does not limit the scope of the disclosure. It should be noted that the flow control device 144 may be provided immediately adjacent to the EGR cooler 124 and/or disposed within the EGR cooler 124.

The flow control device 144 may selectively isolate the EGR cooler 124 from the coolant loop 128. The spring force of the first and/or second check valve 206, 208 may be greater than a static pressure in the system and lesser than a pre-determined flow pressure of the pump 138. The static pressure in the system is essentially equivalent to the force due to the weight of the coolant located gravitationally above the EGR cooler 124. Hence, when the pump 138 is in the active state or operational state, the pump 138 may have the pre-determined flow pressure. The pre-determined flow pressure of the pump 138 may be greater than the spring force of the first check valve 206, thereby allowing flow through the first check valve 206. To this end, the EGR cooler 124 may be supplied with the coolant flow. Further, the coolant flow may be allowed to leave the EGR cooler 124 via second check valve 208.

A person of ordinary skill in the art will appreciate that the coolant may then flow to other coolers present in the system. In one embodiment, the coolant flow from the different coolers may drain into the coolant channels in the power source 102. The coolant from the power source 102 may then flow towards the thermostat controlled valve 114. It should be understood that the coolant flow described herein is on an illustrative basis and may vary without any limitation.

On the other hand, in one embodiment, when the pump 138 is in the inactive state, the flow control device 144 may restrict flow of any coolant into or out of the EGR cooler 124. In one example, the spring force of the first check valve 206 may be greater than the static pressure in the system. As a result, the first check valve 206 may restrict the flow of coolant into and out of the EGR cooler 124.

A person of ordinary skill in the art will appreciate that the flow control device 144 may also be provided at the outlet 136 of the EGR cooler 124 to prevent flow of the coolant into or out of the EGR cooler 124 from the reverse side, when the pump 138 is in the inactive state. It should be noted on failure of the EGR cooler 124, such as, for example, presence of a hole in the EGR cooler 124, the coolant in the coolant loop 128 may enter into the EGR cooler 124 from the inlet 132 or the outlet 136. Due to the hole in the EGR cooler 124, the coolant may leak into the air side of the EGR circuit and collect in the intake manifold 104 and/or cylinders of power source 102 when the power source 102 is in a shutdown condition. In one embodiment, this collected coolant may result in a hydro-lock condition when the power source 102 is re-started. It may be understood that the flow control device 144 located at the outlet 136 of the EGR cooler 124 need not be spring loaded, since the effect of gravity may prevent reverse flow of the coolant into the EGR cooler 124 when the pump 138 is in the inactive condition.

Alternatively, in one embodiment, the flow control device 144 may include an electronically controlled valve. The electronically controlled valve may receive control signals from a controller to either open or close the valve. In another embodiment, the operation of the electronically controlled valve may be based on the operation mode of the pump 138, state of operation of the power source 102, and the like. For example, when the power source 102 may be in a shutdown condition, the flow control device 144 may isolate the EGR cooler 124 from the coolant loop 128.

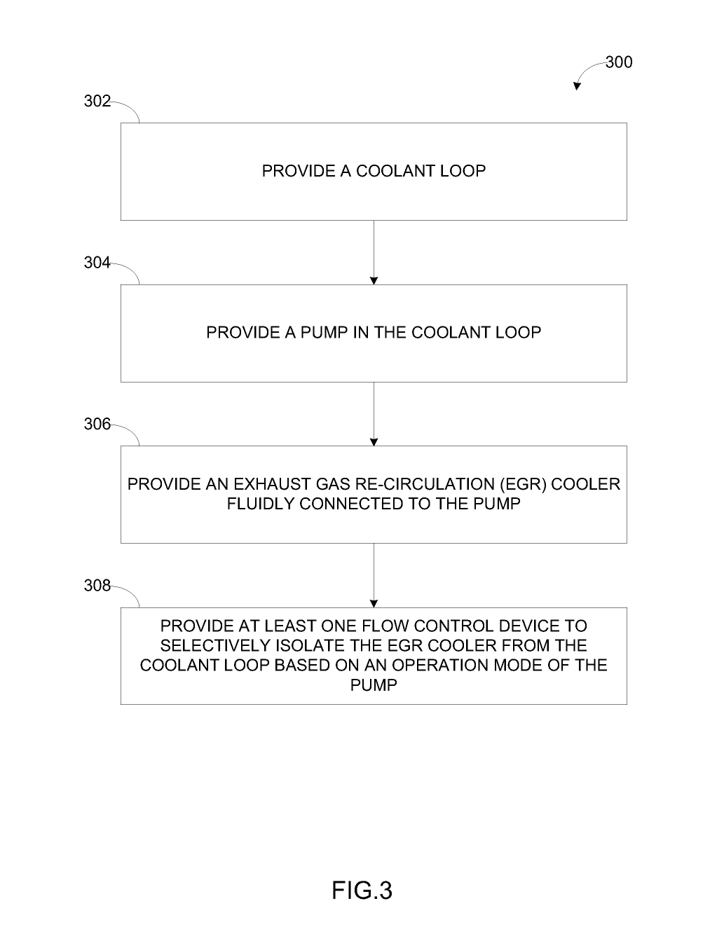

The method for controlling the coolant flow into the EGR cooler 124 will be explained in connection with FIG. 3.

### INDUSTRIAL APPLICABILITY

Power sources 102 using the EGR system 100 may include the EGR cooler 124 to cool the exhaust gases being re-circulated to the intake manifold 104. Occasionally, the EGR cooler 124 may develop a condition where coolant is accidentally introduced into the first and second EGR exhaust lines 122, 126 of an EGR exhaust loop. For example, there may be a leak or hole in the EGR cooler 124 allowing the coolant to leak into the EGR exhaust loop.

During normal operation of the power source 102, the amount of leakage of the coolant introduced into the first and second EGR exhaust lines 122, 126 may not have adverse effects on the system. However, in certain situations, when the power source 102 may be in the shut down condition and the pump 138 may be in the inactive state, the coolant flowing through the coolant loop 128 may seek to drain at the lowest point in the EGR system 100. As a result, the coolant may flow into the EGR cooler 124 from anywhere in the coolant loop 128 and enter into the EGR exhaust loop through the leak in the EGR cooler 124. Moreover, the coolant may pool in the intake manifold 104 and/or the cylinders of the power source 102. In such circumstances, the pooled coolant may cause a hydro-lock condition of the power source 102, on restarting of the power source 102.

The present disclosure may prevent the hydro-lock condition of the power source 102 by providing the flow control device 144 in the coolant loop 128. In one embodiment, the flow control device 144 may selectively isolate the EGR cooler 124 from the coolant loop 128, based on the operation mode of the pump 138. At step 302, the coolant loop 128 may be provided. The pump 138 may be provided in the coolant loop 128 at step 304. In one embodiment, as described earlier, the coolant may flow through the coolant loop 128 via the pump 138. In another embodiment, the coolant may flow towards the pump 138 via the second passageway 112, the bypass line 116 and/or the shunt line 142, fluidly connecting the radiator 108, thermostat controlled valve 114 and the shunt tank 140 respectively to the pump 138.

Further, at step 306, the EGR cooler 124 may be fluidly connected to the pump 138 via the first fluid communication line 130. At step 308, the flow control device 144 may be provided in the coolant loop 128 to selectively isolate the EGR cooler 124 from the coolant loop 128. In one embodiment, the selective isolation of the EGR cooler 124 may be based on the operation mode of the pump 138. In such an embodiment, when the pump 138 is in the active state, the flow control device 144 may supply the EGR cooler 124 with the coolant flow. However, when the pump 138 is in the inactive state, the flow control device 144 may restrict the coolant flow into and out of the EGR cooler 124.

In the present disclosure, the flow control device 144 may prevent the hydro-lock condition of the power source 102, by restricting the amount of the coolant that may pool in the intake manifold 104 and/or cylinder of the power source 102 due to a failure of the EGR cooler 124, when the power source 102 is in shutdown condition. A person of ordinary skill in the art will appreciate that even after the EGR cooler 124 is isolated from the rest of the coolant loop, the coolant present within the EGR cooler 124 itself may flow through the leak into the associated components of the power source 102. However, the amount of the coolant within the EGR cooler 124 is typically a relatively small amount, typically less than approximately one gallon, and may be considered insufficient to cause the hydro-lock condition of the power source 102.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system comprising:
a coolant loop;
a pump disposed in the coolant loop;
an exhaust gas re-circulation (EGR) cooler fluidly connected to the pump; and
at least one flow control device configured to selectively isolate the EGR cooler from the coolant loop based on an operation mode of the pump.

2. The system of claim 1 further including a radiator, wherein the radiator is fluidly connected to the pump and configured to provide a coolant flow to the EGR cooler.

3. The system of claim 1, wherein the at least one flow control device includes a first check valve.

4. The system of claim 3, wherein the at least one flow control device further includes a second check valve.

5. The system of claim 4, wherein the second check valve is disposed in the coolant loop at an outlet of the EGR cooler.

6. The system of claim 3, wherein the first check valve is disposed in the coolant loop between the pump and the EGR cooler.

7. The system of claim 1, wherein the at least one flow control device is disposed in the coolant loop immediately adjacent to the EGR cooler.

8. The system of claim 1, wherein the at least one flow control device is disposed within the EGR cooler.

9. The system of claim 1, wherein the at least one flow control device includes a spring loaded check valve.

10. The system of claim 1, wherein the pump has a pre-determined flow pressure when in an operational state.

11. The system of claim 10, wherein a spring force of the spring loaded check valve is greater than a static pressure in the system and less than the pre-determined flow pressure of the pump.

12. A method comprising:
providing a coolant loop;
providing a pump in the coolant loop;
providing an exhaust gas re-circulation (EGR) cooler fluidly connected to the pump; and
providing at least one flow control device to selectively isolate the EGR cooler from the coolant loop based on an operation mode of the pump.

13. The method of claim 12, wherein selectively isolating the EGR cooler from the coolant loop further includes supplying the EGR cooler with a coolant flow when the pump is in an active state.

14. The method of claim 12, wherein selectively isolating the EGR cooler from the coolant loop further includes restricting a coolant flow into the EGR cooler when the pump is in an inactive state.

15. An exhaust gas re-circulation (EGR) system comprising:
a coolant loop;
a power source;
a pump disposed within the coolant loop;
a radiator configured fluidly connected to the pump, the radiator configured to provide a coolant flow within the coolant loop;
a thermostat fluidly connected between the power source and the radiator, the thermostat configured to selectively bypass at least a portion of the coolant flow towards the pump;
an (EGR) cooler fluidly connected to the power source and the pump; and
at least one flow control device configured to selectively isolate the EGR cooler from the coolant loop based on an operation mode of the pump.

16. The exhaust gas re-circulation system of claim 15, wherein the at least one flow control device is disposed in the coolant loop between the pump and the EGR cooler.

17. The exhaust gas re-circulation system of claim 15, wherein the at least one flow control device is disposed in the coolant loop at an outlet of the EGR cooler.

18. The exhaust gas re-circulation system of claim 15, wherein the at least one flow control device is disposed in the coolant loop immediately adjacent to the EGR cooler.

19. The exhaust gas re-circulation system of claim 15, wherein the at least one flow control device is disposed within the EGR cooler.

20. The exhaust gas re-circulation system of claim 15, wherein the at least one flow control device includes a spring loaded check valve.
